(19) United States
(12) Patent Application Publication
(10) Pub. No.: US 2022/0063888 A1
(43) Pub. Date: Mar. 3, 2022

(54) ARTICLE OF MANUFACTURE

(71) Applicant: AlphaPix Limited, Limerick (IE)

(72) Inventor: Michael O'Connell, Togher (IE)

(21) Appl. No.: 17/459,126

(22) Filed: Aug. 27, 2021

(30) Foreign Application Priority Data
Aug. 28, 2020 (GB) 2013544.8

(51) Int. Cl. B65D 73/00; B65D 5/42; B65D 5/52

(52) U.S. Cl. CPC B65D 73/0021; G09F 1/04; B65D 5/5206; B65D 5/4233

(57) ABSTRACT

This invention relates to an article of manufacture comprising a plurality of sheets including a backing sheet, a front sheet and an intermediate pocket sheet sandwiched between the other two sheets. The pocket sheet comprises a frame with an interior portion cut-out so that when sandwiched between the backing and the front sheets, the plurality of sheets define a cavity. There is further provided a stand comprising an elongate length of material connected at one end to one of the sheets, the other free end terminating in a tab, and having a plurality of fold lines. A separate, removable indicia sheet for reception of a message thereon is provided. The backing sheet comprises a pair of slits, one of which is dimensioned for reception of the indicia sheet to provide access to the cavity, and the other dimensioned to receive the tab of the stand for support of the article of manufacture.

### CROSS-REFERENCE TO RELATED APPLICATIONS

The subject application claims the benefit of Great Britain Patent Application No. 2013544.8, filed on Aug. 28, 2020. The entire disclosure of which is herein incorporated by reference.

### INTRODUCTION

This invention relates to an article of manufacture. More specifically, this invention relates to an article of manufacture that has a plurality of disparate uses and functions, including, inter alia, as a greeting card.

Greeting cards are commonly used in many countries to mark special events or occasions. For example, greeting cards are often used to commemorate birthdays, weddings, the birth of a new child, the start or finish of a job, the passing of a driving test or exam, and the like. Greeting cards are also used for marking special dates such as Valentine's day, as well as to mark sad occasions such as the death of a loved one.

Accordingly, the greeting card may be highly personal in nature. The greeting card will typically comprise a picture or cartoon on a front cover thereof, with a message printed on an inside leaf. The inside leaf often has room for a personalised message to be written by the greeting card giver intended for consumption by the greeting card recipient. The giving of greeting cards is so commonplace in parts of the World that the greeting card business has grown into a multi-billion pound industry.

There are however some problems with the existing offerings. First of all, the most common types of greeting cards are not particularly stable and are prone to blow over in a draught. This is inconvenient particularly for the less mobile or elderly members of society where bending down to pick up a card that has fallen off a mantlepiece or the like is challenging and or tiring to do. Some constructions of greeting card are more stable than others, particularly where a higher gauge card material is used in the greeting card's manufacture. However, this increases the costs of manufacture and shipping of the card. It is understood that other greeting cards are known to come with separate stands however these may be difficult to manipulate, particularly for those that have manual dexterity issues such as arthritis sufferers, and are also more expensive to manufacture and ship.

Another problem with the existing offerings is that often, the greeting card contains a highly personalised message that the recipient or indeed the giver may prefer not to be on general view at a glance to anyone passing by the card. Instead, it would be preferable if the message contained in the card could remain relatively private for the sake of one or both of the recipient and the giver.

A further problem with the existing offerings is that they are relatively limited in their functionality, for example, they are used solely as a greeting card, and accordingly, the market is thereby limited. Ideally, the article of manufacture would have a plethora of disparate uses, thereby appealing to a larger share of the market.

It is an object of the present invention to provide an article of manufacture that overcomes at least some of these problems. It is a further object of the present invention to provide an article of manufacture that can perform multiple disparate uses and therefore have appeal to a broader customer base. It is a further still object of the present invention to provide an article of manufacture that offers a useful alternative choice to the consumer.

### STATEMENTS OF INVENTION

According to the invention there is provided an article of manufacture comprising:
a plurality of sheets including a backing sheet, a front sheet and an intermediate pocket sheet sandwiched between the backing sheet and the front sheet, the pocket sheet comprising a circumferential frame with an interior portion thereof cut-out so that when sandwiched intermediate the backing sheet and the front sheet, the plurality of sheets define a cavity therebetween;
a stand, the stand comprising an elongate length of material connected at one end to one of the sheets, the other free end of which terminating in a tab, the stand having a plurality of fold lines about which the stand can be cranked intermediate its ends;
a separate, removable indicia sheet for reception of a personalized message thereon;
the backing sheet comprising a pair of slits formed therein, one of which is dimensioned for reception of the indicia sheet and providing access through the backing sheet to the cavity for storage of the removable indicia sheet therein, and the other of which is dimensioned to receive the tab of the stand for support of the article of manufacture in a substantially upright configuration.

By having such an article of manufacture, the giver of the article of manufacture can write their personalised message on the indicia sheet and the indicia sheet can be safely stored away in the pocket cavity formed intermediate the sheets of the article of manufacture, away from prying eyes and not in plain sight. The personalised message will still however be readily accessible to the intended recipient and can be stored safely. This is particularly advantageous for articles of manufacture containing very personal messages. In addition, importantly, the article of manufacture has a very simple and stable arrangement of stand that is used to support the article of manufacture. The arrangement of stand will provide a firm platform for the article of manufacture that will be less prone to blowing over in draughts. Furthermore, the configuration of article of manufacture and stand will be simple and intuitive to construct. It will be understood that the article of manufacture may be used as a greeting card however it will also be understood that the article of manufacture can also be used as a picture frame, photo frame or the like. In this way, the appeal and market reach is expanded from the existing offerings.

In one embodiment of the invention there is provided an article of manufacture in which the stand comprises three transverse fold lines along its length, one corresponding to the lower edge of the backing sheet, a second corresponding to the neck of the tab, and the third located intermediate the other two fold lines. This is seen as a simple and effective configuration to implement.

In one embodiment of the invention there is provided an article of manufacture in which the third fold line is located substantially equidistant from the first and second fold lines.

In one embodiment of the invention there is provided an article of manufacture in which there is provided a fourth transverse fold line on the stand, the fourth fold line being located intermediate the first and third fold lines.

In one embodiment of the invention there is provided an article of manufacture in which the stand is constructed from the same material as one or more of the plurality of sheets.

In one embodiment of the invention there is provided an article of manufacture in which the stand is formed integrally with the backing sheet and extends outwardly therefrom. This is seen as a particularly effective configuration that will simplify manufacture. Indeed, the stand could be formed integrally with the front sheet or the intermediate sheet. What is important is that the stand will be stamped from a larger sheet of material at the same time as the sheet to which it is connected, in one unitary piece.

In one embodiment of the invention there is provided an article of manufacture in which the stand has an enlarged portion intermediate two adjacent fold lines. This will facilitate handling of the stand, particularly for those with manual dexterity issues. The enlarged portion may also be embellished with marketing or other ornamentation.

In one embodiment of the invention there is provided an article of manufacture in which the indicia sheet comprises a finger tab along one edge thereof. The finger tab is again seen as useful as it will allow those less dexterous individuals to grasp the indicia sheet and remove it from the cavity with relative ease.

In one embodiment of the invention there is provided an article of manufacture in which the finger tab is provided with a non-slip coating. The non-slip coating may be provided by way of a UV varnish.

In one embodiment of the invention there is provided an article of manufacture in which the non-slip coating is provided by way of an adhesive coating.

In one embodiment of the invention there is provided an article of manufacture in which the slit dimensioned for reception of the indicia sheet is provided a semicircle cut out intermediate its ends. Again, this will facilitate the gripping of the indicia sheet. As an alternative, instead of a semicircle, other shaped cut outs could be provided including, inter alia, an elliptical-shaped cut out.

In one embodiment of the invention there is provided an article of manufacture in which the slit dimensioned for reception of the indicia sheet extends laterally across the backing sheet.

In one embodiment of the invention there is provided an article of manufacture in which the slit dimensioned for reception of the indicia sheet is located adjacent a top edge of the backing sheet and the slit for reception of the tab of the stand is located spaced apart from the first slit and adjacent the bottom edge of the backing sheet. This is seen as a particularly effective configuration of article of manufacture according to the invention.

In one embodiment of the invention there is provided an article of manufacture in which there is provided a second intermediate sheet, located intermediate the front sheet and the pocket sheet. By having a second intermediate sheet, the cavity between the front sheet and the backing sheet can be compartmentalized into a plurality of sections. The indicia sheet may be located in one section and a photograph or other indicia carrying sheet may be located in the other section.

In one embodiment of the invention there is provided an article of manufacture in which the second intermediate sheet is provided with a transverse slit formed therein. The second transverse slit will allow for a photo or other items to be passed through the second intermediate sheet onto the opposite side of the second intermediate sheet from the first intermediate sheet.

In one embodiment of the invention there is provided an article of manufacture in which the transverse slit in the second intermediate sheet is coincident with the slit in the backing sheet that is for reception of the indicia sheet.

In one embodiment of the invention there is provided an article of manufacture in which the transverse slit in the second intermediate sheet is coincident with the slit in the backing sheet that is for reception of the tab of the stand. In this way, this should prevent interference of a photo or other sheet being passed through the slit and the indicia sheet.

In one embodiment of the invention there is provided an article of manufacture in which there is provided a third intermediate sheet located intermediate the front sheet and the second intermediate sheet.

In one embodiment of the invention there is provided an article of manufacture in which the third intermediate sheet has a cut-out formed therein. This will provide a second larger cavity section adjacent the front sheet for reception of a photo or other memento.

In one embodiment of the invention there is provided an article of manufacture in which the front sheet is provided with a viewing window cut-out formed therein.

In one embodiment of the invention there is provided an article of manufacture in which the viewing window cut-out of the front sheet has a smaller area than the area of the cut-out of the third intermediate sheet.

In one embodiment of the invention there is provided an article of manufacture in which the front sheet comprises a plurality of sheets superimposed one on top of the other.

In one embodiment of the invention there is provided an article of manufacture in which adjacent sheets of the article of manufacture other than the indicia sheet are bonded to the nearest adjacent sheet. This is seen as a simple way of connecting the sheets together.

In one embodiment of the invention there is provided an article of manufacture in which the adjacent sheets are bonded together about the periphery thereof.

### DETAILED DESCRIPTION OF THE INVENTION

The invention will now be more clearly understood from the following description of some embodiments thereof given by way of example only with reference to the accompanying drawings, in which:—

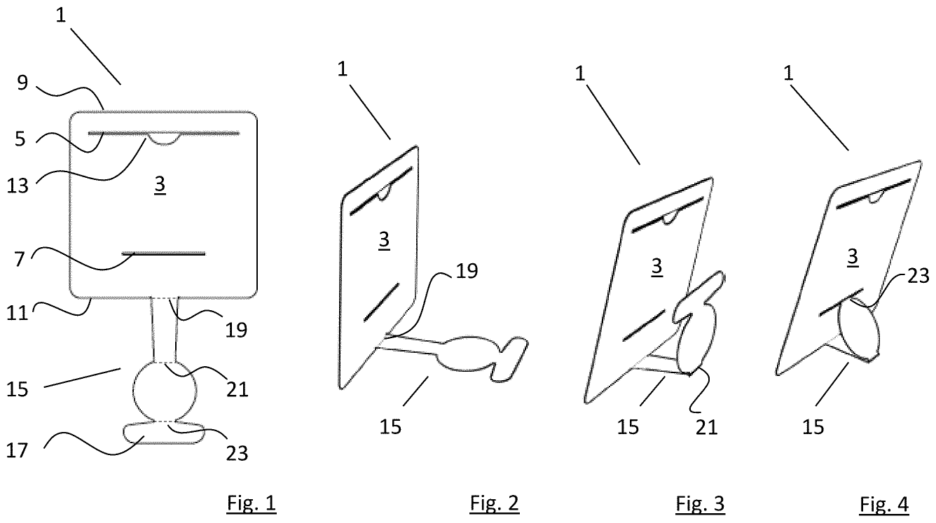

FIG. 1 is a rear view of an article of manufacture according to the invention;

FIG. 2 is a perspective view of the article of manufacture of FIG. 1 with the stand in a first stage of construction;

FIG. 3 is a perspective view of the article of manufacture of FIG. 1 with the stand in a second stage of construction;

FIG. 4 is a perspective view of the article of manufacture of FIG. 1 with the stand constructed;

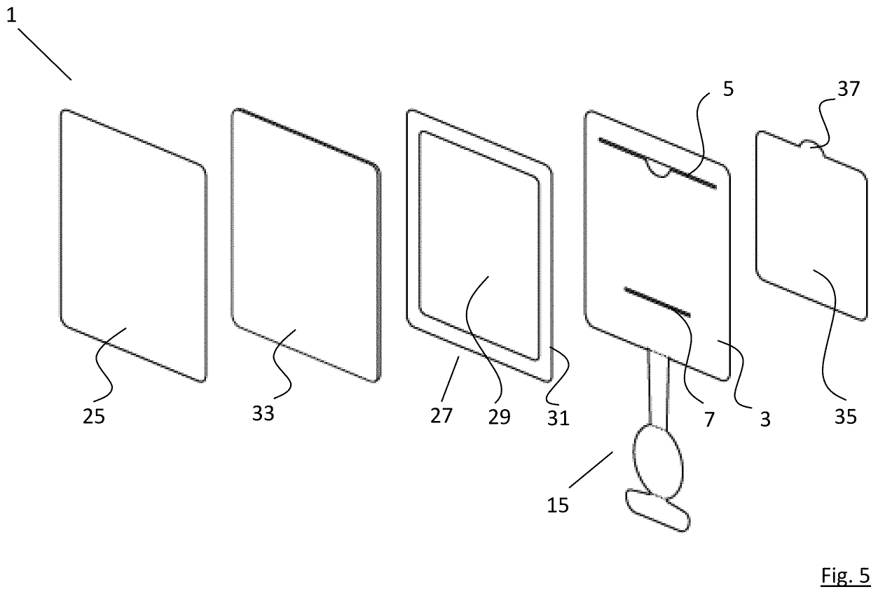

FIG. 5 is an exploded view of a first embodiment of article of manufacture according to the invention;

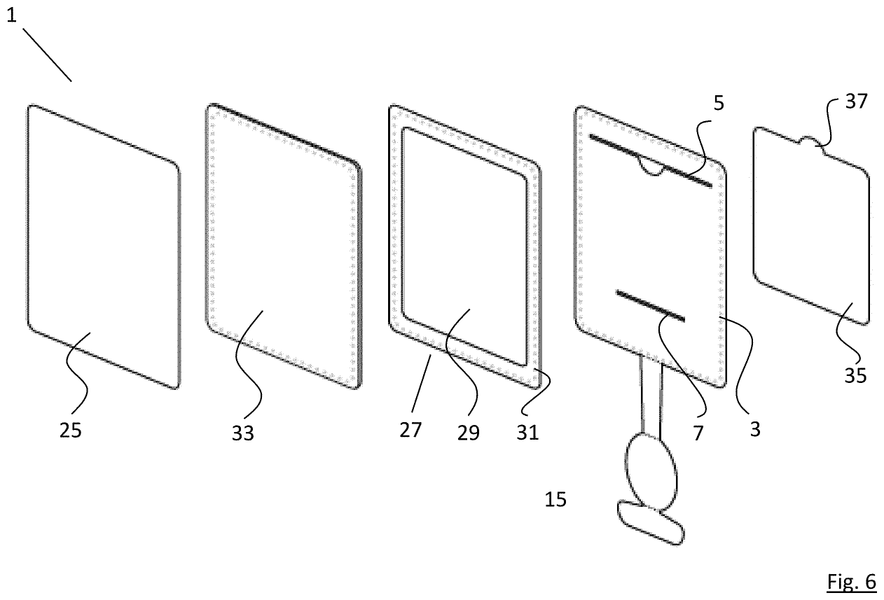

FIG. 6 is a view similar to FIG. 5 showing the glue locations on the sheets;

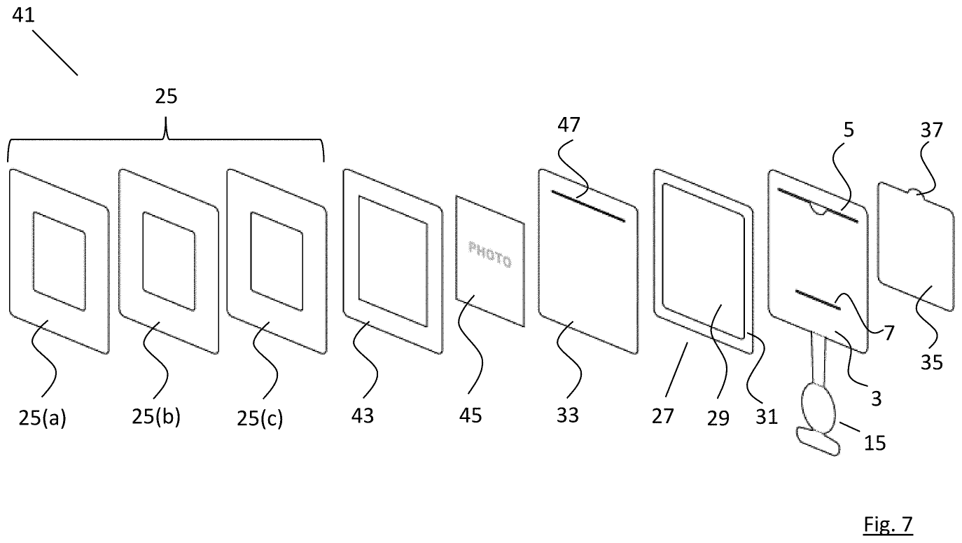

FIG. 7 is an exploded view of a second embodiment of article of manufacture according to the invention;

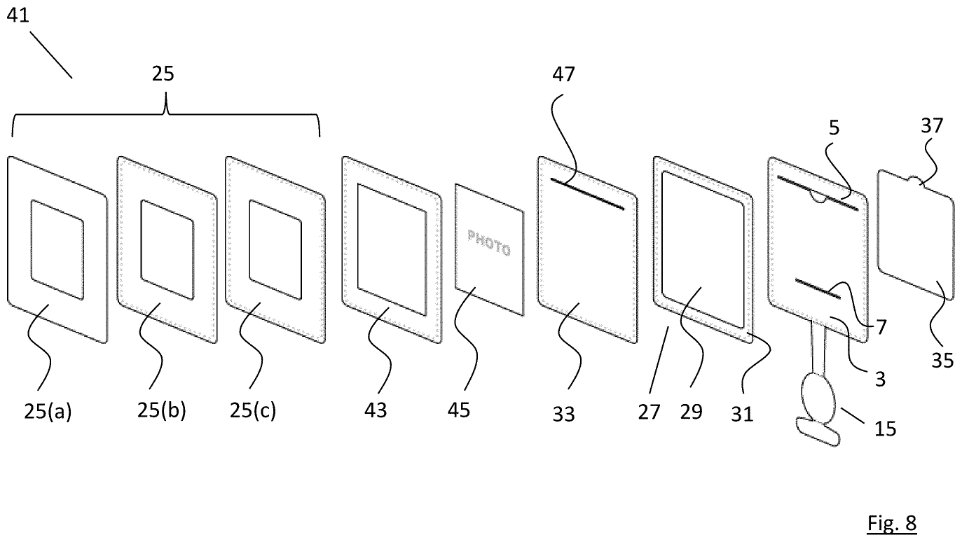

FIG. 8 is a view similar to FIG. 7 showing the glue locations on the sheets;

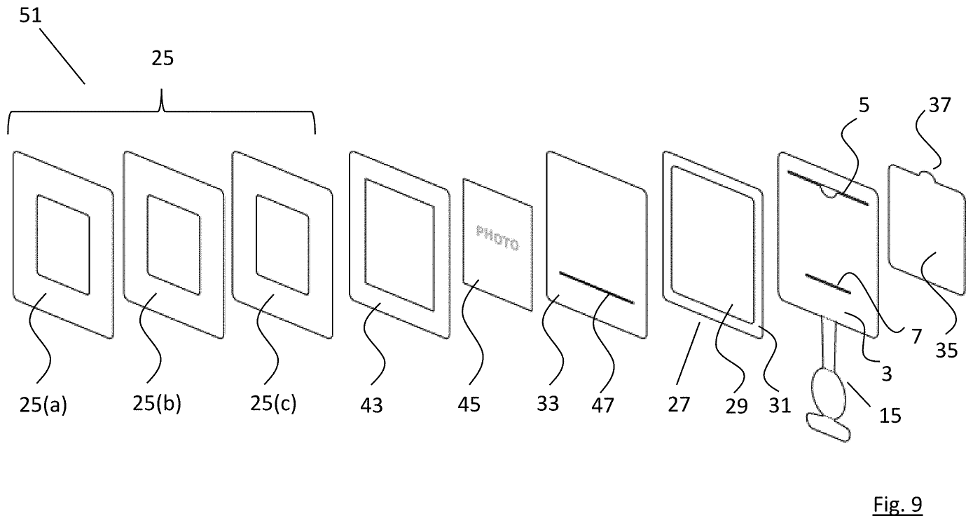

FIG. 9 is an exploded view of a third embodiment of article of manufacture according to the invention;

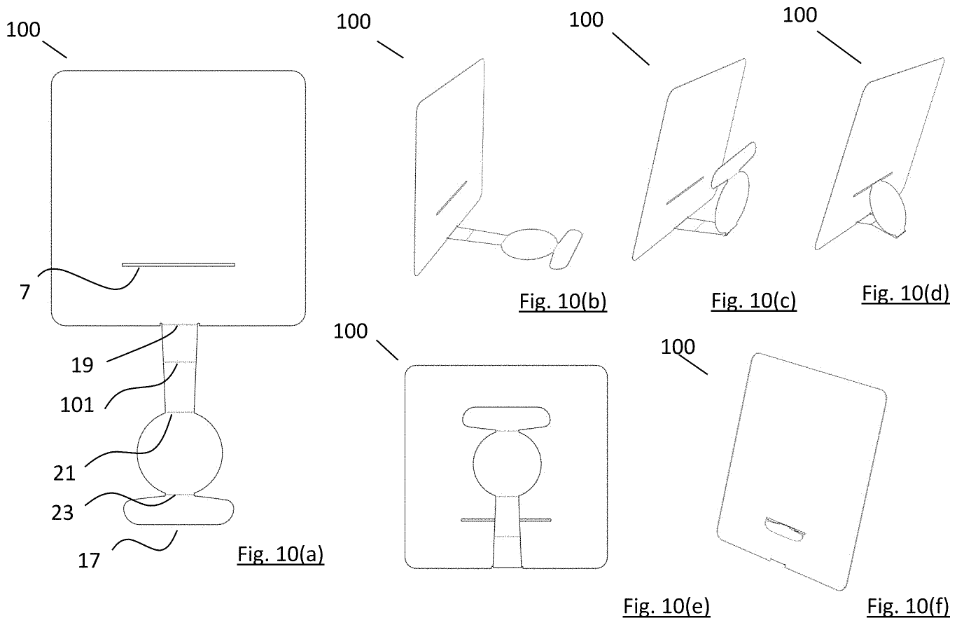

FIGS. 10(a)-10(f) show a first embodiment of backing sheet of an article of manufacture according to the invention in various stages of construction;

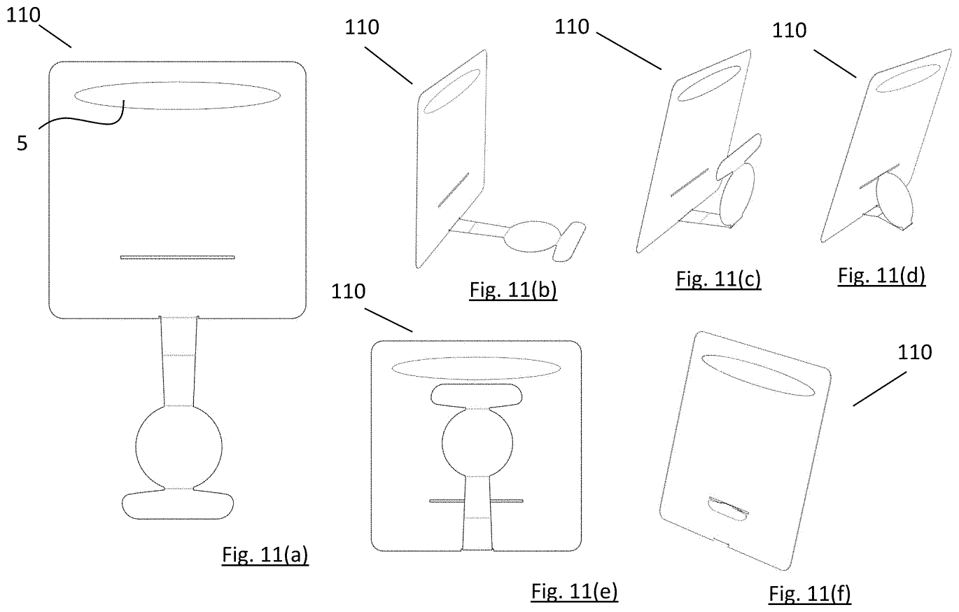

FIGS. 11(a)-11(f) show a second embodiment of backing sheet of an article of manufacture according to the invention in various stages of construction;

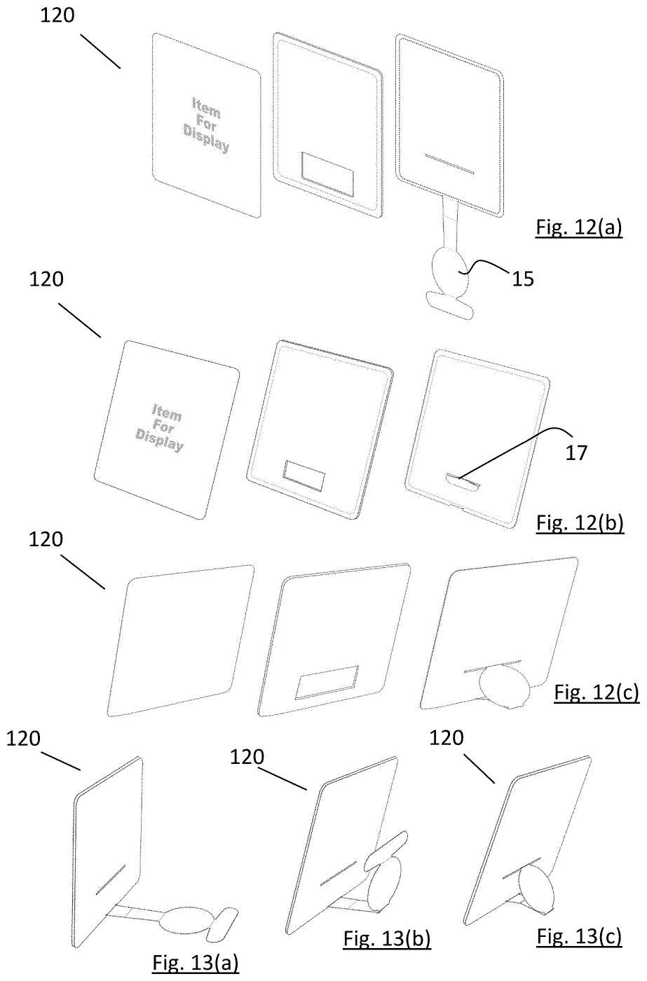

FIGS. 12(a)-12(c) show exploded views of the components of an article of manufacture according to the invention in different stages of construction;

FIGS. 13(a)-13(c) show the backing sheet of FIGS. 12(a)-12(c) in various stages of construction;

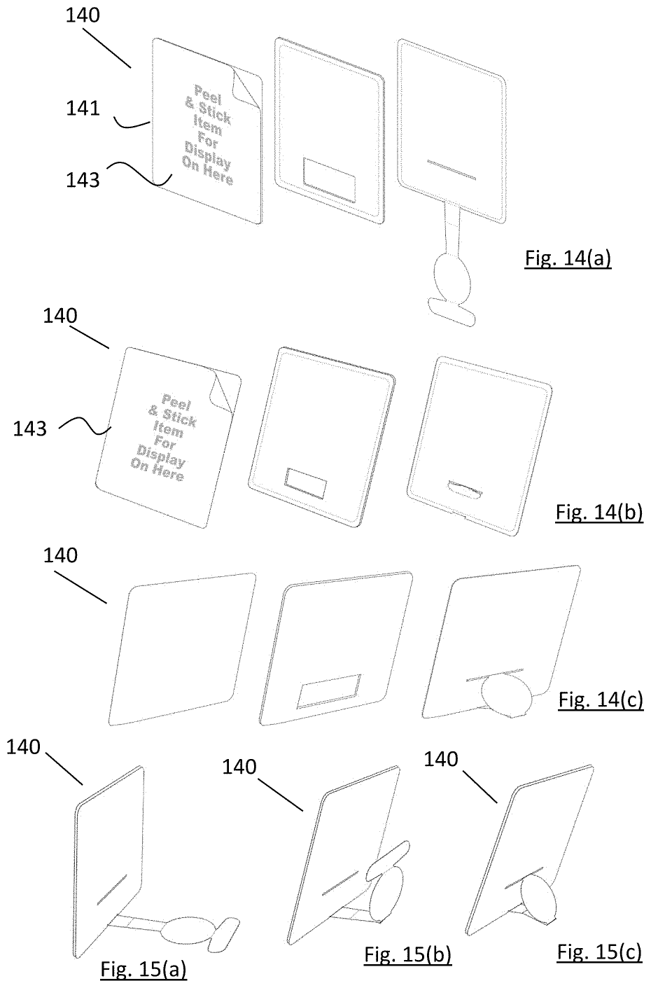

FIGS. 14(a)-14(c) show exploded views of the components of another article of manufacture according to the invention in different stages of construction;

FIGS. 15(a)-15(c) show the backing sheet of FIGS. 14(a)-14(c) in various stages of construction;

FIGS. 16(a) and 16(b) show exploded views of the components of another article of manufacture according to the invention in different stages of construction;

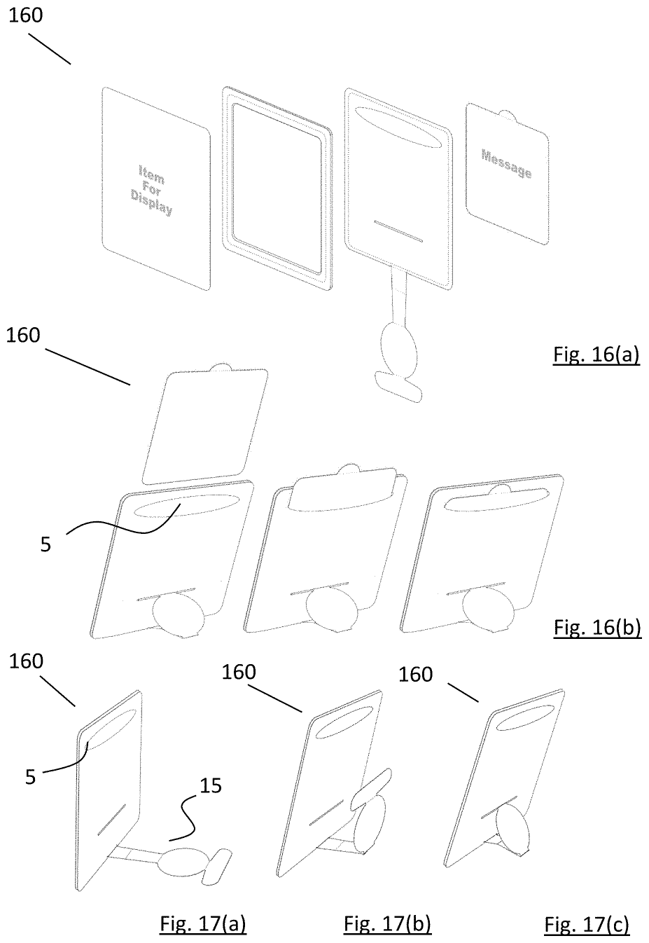

FIGS. 17(a)-17(c) show the backing sheet of FIGS. 16(a)-16(b) in various stages of construction;

FIGS. 18(a) and 18(b) show exploded views of the components of another article of manufacture according to the invention in different stages of construction;

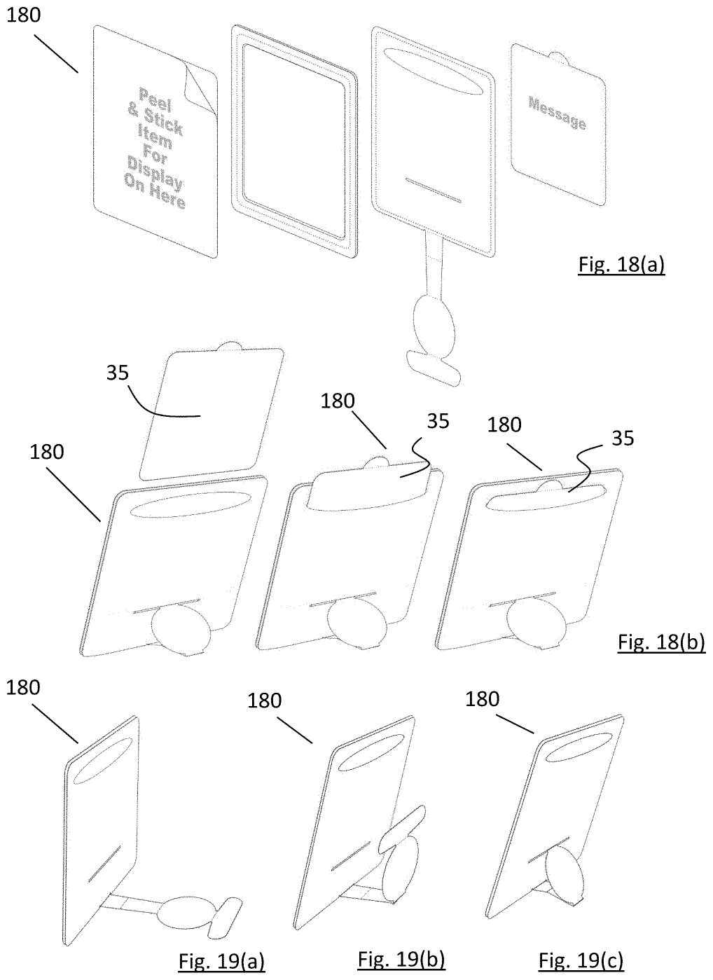

FIGS. 19(a)-19(c) show the backing sheet of FIGS. 18(a)-18(b) in various stages of construction;

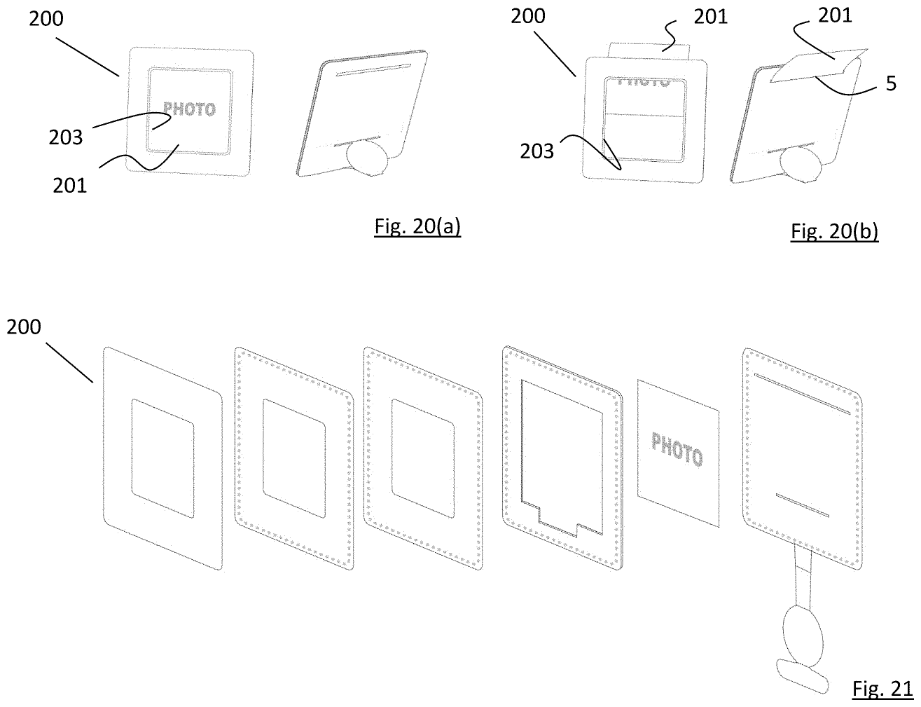

FIGS. 20(a) and 20(b) illustrate the placement of a photograph in another embodiment of article of manufacture;

FIG. 21 is an exploded view of the article of manufacture shown in FIGS. 20(a) and 20(b);

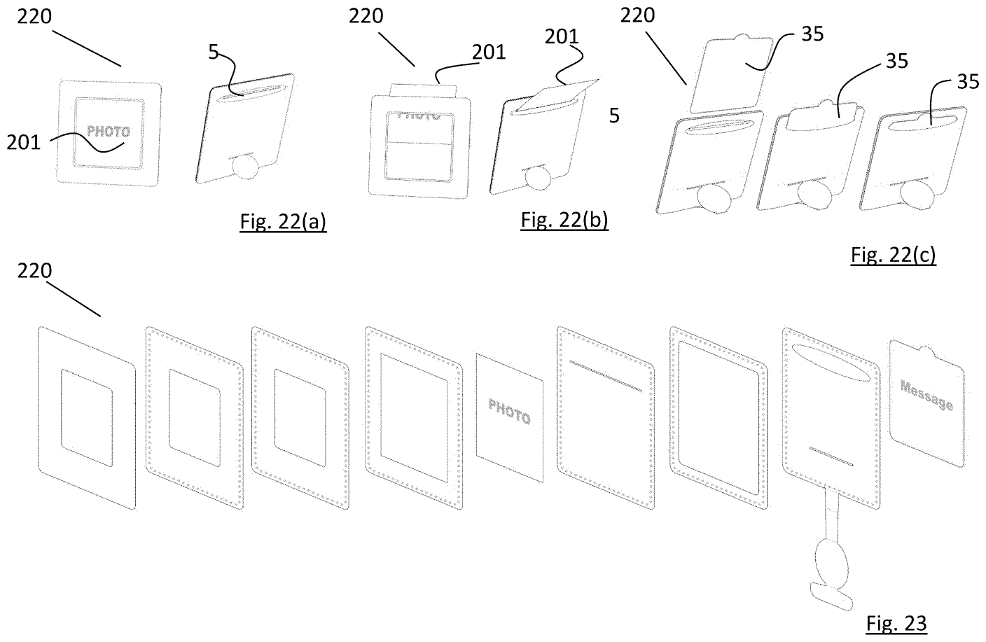

FIGS. 22(a) and 22(c) illustrate the placement of a photograph in another embodiment of article of manufacture;

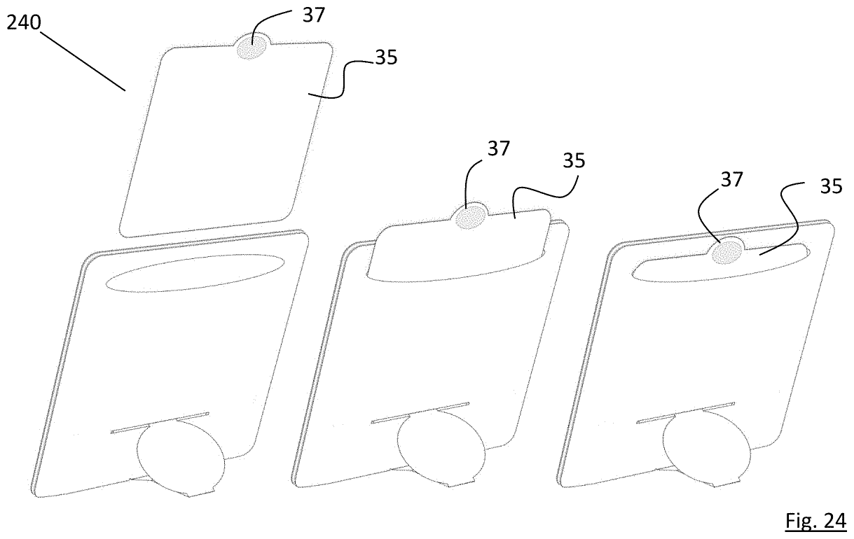

FIG. 23 is an exploded view of the article of manufacture shown in FIGS. 20(a) and 20(b);

FIG. 24 are views illustrating the placement of a message in an article of manufacture;

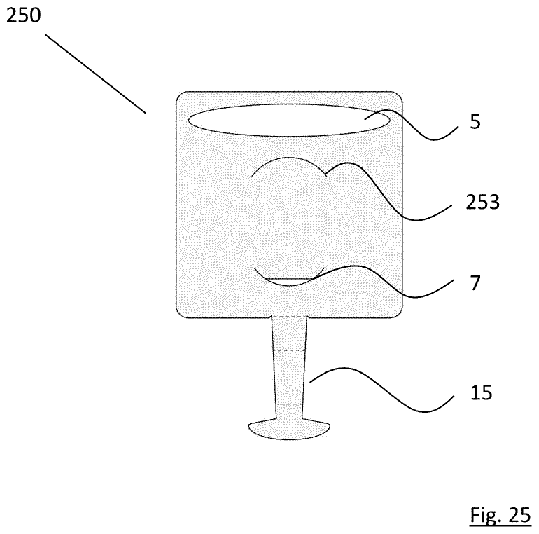

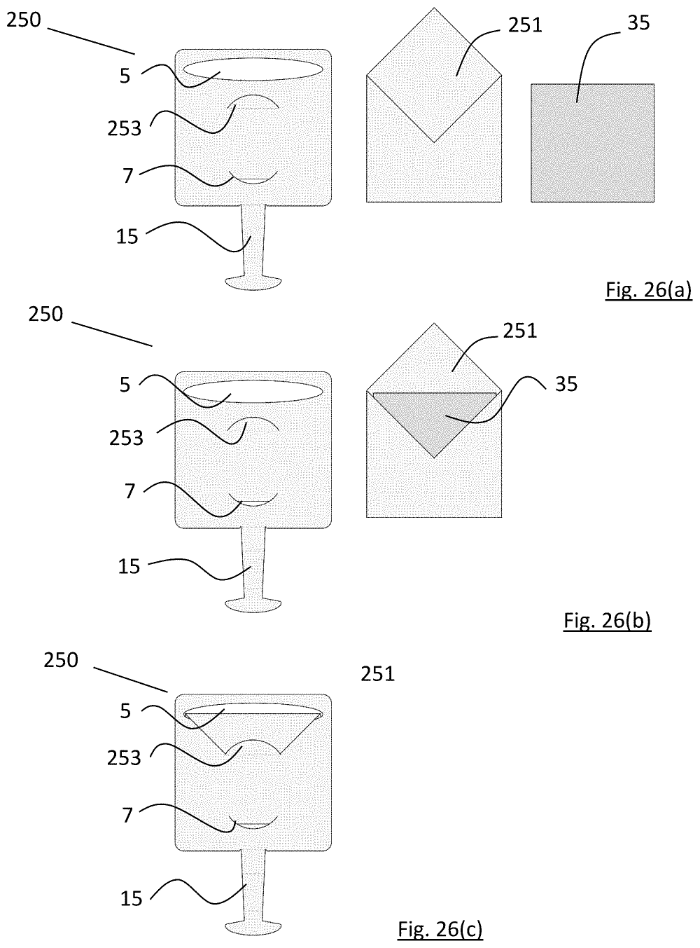

FIG. 25 is a rear view of another backing sheet according to the invention; and

FIGS. 26(a) to 26(c) illustrate placement of an envelope and indicia sheet into an article of manufacture incorporating the backing sheet of FIG. 25.

Referring to FIG. 1, there is shown an article of manufacture, indicated generally by the reference numeral 1, comprising a plurality of sheets, only one of which, a backing sheet 3, is shown. The backing sheet is provided with a pair of transverse slits 5, 7, one of which is dimensioned for reception of an indicia sheet (not shown) and is located adjacent a top edge 9 of the backing sheet 3, and the other of which is spaced apart from the first transverse slit 5 and is located adjacent a bottom edge 11 of the backing sheet 3. The transverse slit 5 has a semi-circular cut-out 13 formed intermediate its ends.

The article of manufacture further comprises a stand, indicated generally by the reference numeral 15, connected at one end to the backing sheet 3 and having at its other free end a tab 17. The tab 17 is dimensioned for reception in the second transverse slit 7 in the backing sheet 3 located adjacent the bottom edge 11 of the backing sheet. The stand 15 has a plurality of transverse fold lines 19, 21, 23 formed therein to allow the stand to be cranked intermediate its ends about the fold lines as will be described in greater detail below with reference to FIGS. 2 to 4 inclusive.

Referring now to FIGS. 2 to 4 inclusive, in order to construct the stand 15, the stand is cranked about first fold line 19 so that the stand 15 protrudes substantially orthogonally to the plane of the backing sheet, as illustrated in FIG. 2. Thereafter, the stand is cranked back on itself about third fold line 21, as illustrated in FIG. 3, before the stand is finally cranked about second fold line 23. Fold line 23 is located at the neck of the tab 17 and permits the tab 17 to be inserted into the second transverse slit 7 in the backing sheet and lie co-planar to the backing sheet 3. Once the tab 17 is inserted into the transverse slot 7, the stand will form a bracing structure to support the article of manufacture in a substantially upright configuration as illustrated in FIG. 4. It will be understood that the construction of the stand is such that it is simple to do and construct even for those with manual dexterity issues.

Referring now to FIGS. 5 and 6, there is shown an exploded view of the article of manufacture 1, showing the other sheets used in the formation of the article of manufacture. The article of manufacture further comprises a front sheet 25 and an intermediate sheet 27 sandwiched between the front sheet 25 and the backing sheet 3. The intermediate sheet 27, also referred to as a pocket sheet, comprises a central cut-out 29 surrounded by a frame 31. In this way, when the front sheet 25, the backing sheet 3 and the intermediate sheet 27 are joined together, they form a pocket or cavity for storage of an indicia sheet. In the embodiment shown, there is further provided a second intermediate sheet 33, located sandwiched between the first intermediate sheet 27 and the front sheet 25. The stand 15 is formed integrally with the backing sheet 3 and extends downwardly therefrom. In addition to the foregoing, there is provided a separate, removable indicia sheet 35. The indicia sheet has a tab 37 along one edge thereof.

In use, an article of manufacture giver may write a personal message on the indicia sheet 35 and once written, can store the indicia sheet in the cavity by passing it through the transverse slit 5 in the backing sheet. The recipient of the article of manufacture may then extract the indicia sheet by clasping the tab 37 between their thumb and forefinger and extracting the indicia sheet 35 from the cavity. Once free of the cavity, the recipient of the article of manufacture can view the message. The recipient may thereafter safely store the message away once more when they have finished viewing the message on the indicia sheet by feeding the indicia sheet back into the cavity through the transverse slit. The front sheet may have a message, a photograph, a picture, a cartoon or other indicia printed on the front face thereof or indeed it may provide a blank space for the creation of an artwork by the article of manufacture giver.

Referring specifically to FIG. 6, it can be seen that the backing sheet 3 and the first and second intermediate sheets 27, 33 have a trace of glue around the periphery thereof for bonding the sheets to their next adjacent sheet.

Referring to FIGS. 7 and 8, there is shown an exploded view of a second embodiment of article of manufacture, indicated generally by the reference numeral 41, showing the sheets used in the formation of the article of manufacture, where like parts have been given the same reference numeral as before. The article of manufacture 41 comprises a third intermediate sheet 43 located between the second intermediate sheet 33 and the front sheet 25, and a photo sheet 45 located between the second intermediate sheet 33 and the third intermediate sheet 43. The second intermediate sheet 33 has a transverse slit 47 formed therein, coincident with the first transverse slit 5 in the backing sheet 3. The front sheet 25 comprises three separate sheets 25(a), 25(b) and 25(c) that are bonded together. The third intermediate sheet 43 has a frame surrounding a cut-out portion thereby defining a second pocket in the interior of the article of manufacture between the second intermediate sheet and the front sheet 25 once the sheets are all bonded together.

In use, the photo sheet 45 is inserted into the second cavity by passing the photo through the first transverse slit 5 in the backing sheet 3, through the cut-out in the first intermediate sheet 27 and through the transverse slit 47 in the second intermediate sheet 33, so that the photo sheet sits on the side of the second intermediate sheet 33 proximal to the front sheet 25 and distal from the backing sheet 3. The indicia sheet 35 may be manipulated in the same manner as described before.

Referring specifically to FIG. 8, it can be seen that the backing sheet 3, the first, second and third intermediate sheets 27, 33, 43, and the front sheets 25(b) and 25(c), all have a trace of glue around the periphery thereof for bonding each of the sheets to their next adjacent sheet.

Referring to FIG. 9, there is seen an exploded view of a third embodiment of article of manufacture, indicated generally by the reference numeral 51, showing the sheets used in the formation of the article of manufacture, where like parts have been given the same reference numeral as before. The article of manufacture 51 is similar to the article of manufacture 41 shown in FIGS. 7 and 8 with the exception that the transverse slit 47 in the second intermediate sheet 33 is located coincident with the second transverse slit 7 in the backing sheet.

In order to place the photo into position in the second cavity/pocket on the side of the second intermediate sheet 33 proximal the front sheet 25 and distal from the backing sheet 3, the photo sheet 45 is passed through the second transverse slit 7 in the backing sheet 3, through the cut-out in the first intermediate sheet 27 and through the transverse slit 47 in the second intermediate sheet 33, so that the photo sheet sits on the side of the second intermediate sheet 33 proximal to the front sheet 25 and distal from the backing sheet 3.

Referring to FIGS. 10(a) to 10(f), there is shown a backing sheet of an article of manufacture in various stages of construction, indicated generally by the reference numeral 100, where like parts have been given the same reference numeral as before. FIG. 10(a) shows a rear view of the backing sheet 100. The backing sheet has a stand 15, as before, however in this embodiment the stand 15 has a fourth fold line 101 intermediate the first fold line 19 and third fold line 21. In FIG. 10(b), there is shown a rear perspective view in which the stand has been cranked about first fold line 19. In FIG. 10(c), there is shown a rear perspective view in which the stand has been cranked about third fold line 21. In FIG. 10(d), there is shown a rear perspective view in which the stand 15 has been cranked about its second fold line 23 and the tab has been inserted into transverse slit 7. FIG. 10(e) shows a rear view of the backing sheet 100 with the stand 15 bent back on itself along the rear of the backing sheet. The stand is put into this position when the article of manufacture is placed in packaging for storage or in an envelope for posting. FIG. 10(f) is a front perspective view of the backing sheet 100 with the tab 17 inserted through the transverse slot 7 and the stand shown bent about its second fold line 23.

Referring to FIGS. 11(a) to 11(f), there is shown a backing sheet of an article of manufacture in various stages of construction, indicated generally by the reference numeral 110. The FIGS. 11(a) to 11(f) are identical to the drawings shown in FIGS. 10(a) to 10(f) with the exception that the backing sheet 110 has an elliptically shaped transverse slit/cut out 5, suitable for reception of an indicia sheet.

Referring to FIGS. 12(a) to 12(c), there are shown a plurality of exploded views of an article of manufacture, indicated generally by the reference numeral 120. The article of manufacture 120 differs from the embodiments previously shown in that there is no pocket for reception of an indicia sheet. Instead, there is a pocket dimensioned to receive the tab 17 of the stand 15. FIGS. 13(a) to 13(c) show the stand 15 of the article of manufacture 120 being constructed.

Referring to FIGS. 14(a) to 14(c), there are shown a plurality of exploded views of an article of manufacture, indicated generally by the reference numeral 140. The views 14(a) to 14(c) are similar to those shown in FIGS. 12(a) to 12(c) with the exception being that the article of manufacture 140 comprises a peel-away adhesive sheet 141 with a sacrificial layer 143 as a protective front sheet. The sacrificial layer 143 is peeled off, exposing an adhesive coating, and an item to be displayed, which may be a photo, painting, drawing, artwork or other materials are stuck onto the adhesive coating. FIGS. 15(a) to 15(c) inclusive show the stand 15 of the article of manufacture 140 being constructed.

Referring now to FIGS. 16(a) and 16(b), there is shown other views of an alternative construction of article of manufacture, indicated generally by the reference numeral 160, with an indicia sheet 35. Referring specifically to FIG. 16(a), there is shown an exploded view of the article of manufacture. Referring specifically to FIG. 16(b), there is shown a rear view of the article of manufacture in various stages of the indicia sheet 35 being inserted into the transverse, elliptically-shaped, slit 5. FIGS. 17(a) to 17(c) inclusive show the stand 15 of the article of manufacture 160 being constructed.

Referring to FIGS. 18(a), 18(b) and 19(a) to 19(c) inclusive, there are shown views of an alternative construction of article of manufacture, indicated generally by the reference numeral 180. The views are very similar in order and format to those shown above in relation to FIGS. 16(a), 16(b) and 17(a) to 17(c) inclusive, respectively, with the exception that the article of manufacture 180 comprises a peel-away adhesive sheet 141 with a sacrificial layer 143 as a protective front sheet.

Referring now to FIGS. 20(a), 20(b) and 21, there is shown a plurality of views of another still embodiment of article of manufacture, indicated generally by the reference numeral 200. Referring first of all to FIG. 20(a), there is shown side by side a front view and a rear perspective view of the article of manufacture. The article of manufacture 200 is configured to accept a photograph 201 for display through a front aperture 203. Referring to FIG. 20(b), there is shown side by side a front view and a rear perspective view of the photograph 201 being inserted into a transverse slit 5 in the rear sheet of the article of manufacture. Referring to FIG. 21, there is shown an exploded view of the article of manufacture 200.

Referring now to FIGS. 22(a), 22(b), 22(c) and 23, there is shown a plurality of views of another still embodiment of article of manufacture, indicated generally by the reference numeral 220. Outwardly in appearance, the article of manufacture 220 is practically identical to the article of manufacture displayed in FIG. 20. The article of manufacture 220 is configured to accept a photograph 201 for display through a front aperture 203, as well as retain an indicia sheet 35. Referring to FIG. 22(b), there is shown side by side a front view and a rear perspective view of the photograph 201 being inserted into a elliptically shaped transverse slit 5 in the rear sheet of the article of manufacture. Referring to FIG. 22(c), there is shown side by side a front view and a rear perspective view of the indicia sheet 35 being inserted into the elliptically shaped transverse slit 5 in the rear sheet of the article of manufacture. The photograph and the indicia sheet are preferably on opposite sides of a separating sheet but they needn't be if desired. Referring to FIG. 23, there is shown an exploded view of the article of manufacture 220.

Referring now to FIG. 24, there is shown a plurality of views of an article of manufacture 240 in which the indicia sheet 35 is being inserted into the transverse slit 5. It can be seen that there is a tab 37 on the indicia sheet 35 with a UV varnish coating that will allow the indicia sheet 35 to be gripped and removed from the article of manufacture 240 with ease.

Referring now to FIG. 25, there is shown a rear view of another embodiment of backing (rear) sheet of an article of manufacture according to the invention, indicated generally by the reference numeral 250, where like parts have been given the same reference numeral as before. Backing sheet 250 comprises three transverse slits, an elliptically shaped transverse slit 5 dimensioned for reception of the indicia sheet (not shown) and providing access through the backing sheet to the cavity for storage of the removable indicia sheet therein, a second transverse slit 7 dimensioned to receive the tab of the stand 15 for support of the article of manufacture in a substantially upright configuration, and a third slit 253 intermediate the other two slits 5, 7.

Referring to FIGS. 26(a) to 26(c) inclusive, there is shown a plurality of views of the article of manufacture 250 in which there is provided an indicia sheet 35 and an envelope 251 for insertion through the transverse slit 5. In FIG. 26(b), the indicia sheet is placed in the envelop 251. In FIG. 26(c) the indicia sheet 35 and envelope 251 and inserted into the transverse slit 5 with the flap portion of the envelope remaining free of the transverse slit 5. Instead, the flap portion of the envelope is folded back on itself and the lower edge of the flap portion is inserted into the transverse slit 253. In this way, the flap of the envelope will be kept safely and can be used to retrieve the envelope out from the transverse slit 5 in due course.

It will be understood that the article of manufacture 240 described herein will be particularly suited as a greeting card however other uses are envisaged. For example, the article of manufacture could be used as a picture frame, a photo frame or indeed for menus or other signage if desired and is not limited to use as a greeting card unless so limited in the claims.

In this specification the terms “comprise, comprises, comprised and comprising” and the terms “include, includes, included and including” are all deemed interchangeable and should be afforded the widest possible interpretation.

The invention is not solely limited to the embodiments hereinbefore described but may be varied in both construction and detail within the scope of the appended claims.

1) An article of manufacture comprising:
a plurality of sheets including a backing sheet, a front sheet and an intermediate pocket sheet sandwiched between the backing sheet and the front sheet, the pocket sheet comprising a circumferential frame with an interior portion thereof cut-out so that when sandwiched intermediate the backing sheet and the front sheet, the plurality of sheets define a cavity therebetween;
a stand, the stand comprising an elongate length of material connected at one end to one of the sheets, the other free end of which terminating in a tab, the stand having a plurality of fold lines about which the stand can be cranked intermediate its ends;
a separate, removable indicia sheet for reception of a personalized message thereon;
the backing sheet comprising a pair of slits formed therein, one of which is dimensioned for reception of the indicia sheet and providing access through the backing sheet to the cavity for storage of the removable indicia sheet therein, and the other of which is dimensioned to receive the tab of the stand for support of the article of manufacture in a substantially upright configuration.

2) The article of manufacture as claimed in claim 1 in which the stand comprises three transverse fold lines along its length, one corresponding to the lower edge of the backing sheet, a second corresponding to the neck of the tab, and the third located intermediate the other two fold lines.

3) The article of manufacture as claimed in claim 2 in which the third fold line is located substantially equidistant from the first and second fold lines.

4) The article of manufacture as claimed in claim 1 in which the stand is constructed from the same material as one or more of the plurality of sheets.

5) The article of manufacture as claimed in claim 1 in which the stand is formed integrally with the backing sheet and extends outwardly therefrom.

6) The article of manufacture as claimed in claim 1 in which the stand has an enlarged portion intermediate two adjacent fold lines.

7) The article of manufacture as claimed in claim 1 in which the indicia sheet comprises a finger tab along one edge thereof.

8) The article of manufacture as claimed in claim 1 in which the slit dimensioned for reception of the indicia sheet is provided a semicircle cut out intermediate its ends.

9) The article of manufacture as claimed in claim 1 in which the slit dimensioned for reception of the indicia sheet extends laterally across the backing sheet.

10) The article of manufacture as claimed in claim 1 in which the slit dimensioned for reception of the indicia sheet is located adjacent a top edge of the backing sheet and the slit for reception of the tab of the stand is located spaced apart from the first slit and adjacent the bottom edge of the backing sheet.

11) The article of manufacture as claimed in claim 1 in which there is provided a second intermediate sheet, located intermediate the front sheet and the pocket sheet.

12) The article of manufacture as claimed in claim 11 in which the second intermediate sheet is provided with a transverse slit formed therein.

13) The article of manufacture as claimed in claim 11 in which there is provided a third intermediate sheet located intermediate the front sheet and the second intermediate sheet.

14) The article of manufacture as claimed in claim 13 in which the third intermediate sheet has a cut-out formed therein.

15) The article of manufacture as claimed in claim 1 in which the front sheet is provided with a viewing window cut-out formed therein.

16) The article of manufacture as claimed in claim 1 in which the front sheet comprises a plurality of sheets superimposed one on top of the other.

17) The article of manufacture as claimed in claim 1 in which adjacent sheets of the article of manufacture other than the indicia sheet are bonded to the nearest adjacent sheet.

18) The article of manufacture as claimed in claim 1 in which the front sheet has an adhesive coating and a sacrificial sheet protecting the adhesive coating.

19) An article of manufacture comprising:
a plurality of sheets including a backing sheet, a front sheet and an intermediate pocket sheet sandwiched between the backing sheet and the front sheet, the pocket sheet comprising a circumferential frame with an interior portion thereof cut-out so that when sandwiched intermediate the backing sheet and the front sheet, the plurality of sheets define a cavity therebetween;
a stand, the stand comprising an elongate length of material connected at one end to one of the sheets, the other free end of which terminating in a tab, the stand having a plurality of fold lines about which the stand can be cranked intermediate its ends;
the backing sheet comprising a transverse slit formed therein, dimensioned to receive the tab of the stand for support of the article of manufacture in a substantially upright configuration.

20) An article of manufacture comprising:
a plurality of sheets including a backing sheet, a front sheet and an intermediate pocket sheet sandwiched between the backing sheet and the front sheet, the pocket sheet comprising a circumferential frame with an interior portion thereof cut-out so that when sandwiched intermediate the backing sheet and the front sheet, the plurality of sheets define a cavity therebetween;
a stand, the stand comprising an elongate length of material connected at one end to one of the sheets, the other free end of which terminating in a tab, the stand having a plurality of fold lines about which the stand can be cranked intermediate its ends;
a separate, removable indicia sheet for reception of a personalized message thereon;
the backing sheet comprising a pair of slits formed therein, one of which is dimensioned for reception of the indicia sheet and providing access through the backing sheet to the cavity for storage of the removable indicia sheet therein, and the other of which is dimensioned to receive the tab of the stand for support of the article of manufacture in a substantially upright configuration; and
in which there is provided a second intermediate sheet, located intermediate the front sheet and the pocket sheet, the second intermediate sheet is provided with a transverse slit formed therein; and there is provided a third intermediate sheet located intermediate the front sheet and the second intermediate sheet, the third intermediate sheet has a cut-out formed therein.
